(19) United States
(12) Patent Application Publication
(10) Pub. No.: US 2010/0264729 A1
(43) Pub. Date: Oct. 21, 2010

(54) POWER SUPPLY CIRCUIT AND LIGHTING SYSTEM

(75) Inventors: Junichi Matsuda, Tokyo (JP); Tomoyuki Fukuda, Tokyo (JP); Shinichi Hotta, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: NEC CORPORATION, Tokyo (JP); NEC LIGHTING, LTD., Tokyo (JP)

(21) Appl. No.: 12/159,191

(22) PCT Filed: Dec. 22, 2006
(86) PCT No.: PCT/JP2006/325581

§ 371 Date: Jun. 25, 2008

(30) Foreign Application Priority Data
Dec. 26, 2005 (JP) 2005-372750

(51) Int. Cl. H02J 1/00

(52) U.S. Cl. 307/11

(57) ABSTRACT

[Problems to be Solved] In technology for identifying the position of an indoor terminal with high accuracy, the cost for installing a transmitter is high for the introduction of the position identifying technique which uses a transmitter to send a weak electric wave such as in Bluetooth, RFID, and the like, or an emitter to emit an infrared ray.

[Means to Solve the Problems] Power is acquired from the existing lighting equipment to operate the transmitter which sends a weak electric wave such as in Bluetooth, RFID, and the like, or an emitter which emits an infrared ray.

### APPLICABLE FIELD IN THE INDUSTRY

The present invention relates to a power supply circuit, and particularly to a power supply circuit which acquires a power from the internal circuit of a lighting equipment.

### BACKGROUND ART

Technology for identifying the position of an indoor terminal with high accuracy is watched. Specifically, the technology using the signal of a wireless LAN (Local Area Network) set by the business enterprises, stores, and the like, and the other position identifying technologies employing Bluetooth, RFID (Radio Frequency Identification) and the like are known.

In general, in order to identify the position of a terminal with high accuracy by using a wireless LAN, it is necessary that the signals can be received from three or more wireless LAN base stations. In the existing wireless LAN base stations mostly located in suitable positions without performing any relative technological designing, the capability of receiving the signals from three or more wireless LAN base stations is not guaranteed.

In order to identify the position of a terminal by using a transmitter which transmits a weak electric wave such as in Bluetooth, RFID, and the like, or an emitter which emits an infrared ray, the terminal functions to receive the weak electric wave or infrared ray. Therefore, when this terminal receives the weak electric wave or the infrared ray, the position of the transmitter or emitter which transmits the weak electric waves or emits the infrared rays is identified as the position of the terminal. For this reason, the arriving distance of the weak electric wave or infrared ray is regarded as the position-fix accuracy, and pinpoint positioning is feasible. However, a great number of transmitters are required to be arranged on the wall or the ceiling.

However, this creates a problem of an increase in the cost for installing the transmitters which transmit weak electric waves such as in Bluetooth, RFID or the like, or for installing the emitter which emits an infrared ray. That is because power supply is required to be secured for each transmitter of a weak electric wave such as in Bluetooth, RFID and the like, or for each emitter which emits the infrared rays, and this needs an expenditure for the installing works of the power supply.

### DISCLOSURE OF THE INVENTION

### Problems to be Solved by the Invention

In order to solve the above-mentioned problem discussed, there is provided a technology in which the transmitter is connected to the lighting equipment, and power is secured from the lighting equipment to transmit a weak electric wave.

However, as described in the foregoing, in order to identify the position of a terminal with high accuracy, there is a need for a great number of transmitters. For this reason, even when the transmitter is not in operation, power is inevitably taken out from the lighting equipment, and this may cause loss of power, thereby allowing the overall cost to be increased for this position identifying arrangement.

Also, when any ground leakage, short-circuit, or other similar problem takes place upon the transmitter connected to the lighting equipment, the lighting equipment may be adversely affected.

A problem to be solved by the present invention is to remove the above-mentioned problem, and specifically, to provide technology for realizing an indoor terminal locating high-accuracy technique at a low cost.

Also, another problem to be solved by the present invention is to provide technology in which the lighting equipment is not affected even when any ground leakage, short-circuit, or other trouble occurs in the transmitter or emitter connected to the lighting equipment.

Moreover, further problem to be solved by the present invention is to provide technology in which the fluorescent lamp of the lighting equipment is not affected in its effective life.

### Means for Solving the Problems

A first invention for solving the above-mentioned problems is a power supply circuit connected to a lighting equipment comprising a fluorescent lamp and a ballast which lights up this fluorescent lamp, to obtain power from the internal circuit of this lighting equipment, and the power supply circuit is characterized by that it has an insulating section which isolates the internal circuit electrically therefrom.

A second invention for solving the above-mentioned problems is characterized by that in the above-mentioned first invention, the insulating section comprises a transformer.

A third invention for solving the above-mentioned problems is characterized by that in the above-mentioned first or second invention, the power supply circuit has a rectifying circuit in which the inputted voltage is rectified and outputted, an interface which can be connected to the lighting equipment, and an interface which can be joined to an external electric appliance.

A fourth invention for solving the above-mentioned problems is characterized by that in the above-mentioned first or second invention, the power supply circuit has a voltage boosting circuit in which the inputted voltage is raised and outputted, an interface which can be connected to the lighting equipment, and an interface which can be joined to an external electric appliance.

A fifth invention for solving the above-mentioned problems is characterized by that in the above-mentioned fourth invention, the voltage boosting circuit has an operation controlling section which is only actuated when the impressed voltage meets a predetermined first condition, and an operation retarding section which is connected to the operation controlling section in which voltage meeting the first condition is applied to the operation controlling section after a predetermined period of time has elapsed commencing with the startup of the lighting equipment.

A sixth invention for solving the above-mentioned problems is characterized by that in one of the above-mentioned first to the fifth inventions, the power supply circuit has a power accumulating circuit of inputted current which outputs the accumulated current according to necessity.

A seventh invention for solving the above-mentioned problems is characterized by that in one of the above-mentioned first to sixth inventions, the insulating section is arranged in the interior of the lighting equipment.

An eighth invention for solving the above-mentioned problems is characterized by that in one of the above-mentioned first and sixth inventions, the insulating section is arranged in the fluorescent lamp.

A ninth invention for solving the above-mentioned problems is characterized by that in one of the above-mentioned first to eighth inventions, the insulating section is connected such that it is in parallel with a preheating filament located in the interior of the fluorescent lamp.

A tenth invention for solving the above-mentioned problems is characterized by that in one of the above-mentioned first to ninth inventions, the insulating section is arranged in the ballast.

An eleventh invention for solving the above-mentioned problems is characterized by that in the above-mentioned seventh invention, the rectifying circuit is arranged in the interior of the lighting equipment.

A twelfth invention for solving the above-mentioned problems is characterized by that in the above-mentioned eighth invention, the rectifying circuit is arranged in the fluorescent lamp.

A thirteenth invention for solving the above-mentioned problems is characterized by that in the above-mentioned tenth invention, the rectifying circuit is arranged in the ballast.

A fourteenth invention for solving the above-mentioned problems is characterized by that in the above-mentioned eleventh invention, the voltage boosting circuit is arranged in the interior of the lighting equipment.

A fifteenth invention for solving the above-mentioned problems is characterized by that in the above-mentioned twelfth invention, the voltage boosting circuit is arranged in the fluorescent lamp.

A sixteenth invention for solving the above-mentioned problems is characterized by that in the above-mentioned thirteenth invention, the voltage boosting circuit is arranged in the ballast.

A seventeenth invention for solving the above-mentioned mentioned problems is characterized by that in the above-mentioned fourteenth invention, the startup retarding circuit is arranged in the interior of the lighting equipment.

An eighteenth invention for solving the above-mentioned problems is characterized by that in the above-mentioned fifteenth invention, the startup retarding circuit is arranged in the fluorescent lamp.

A nineteenth invention for solving the above-mentioned problems is characterized by that in the above-mentioned sixteenth invention, the startup retarding circuit is arranged in the ballast.

A twentieth invention for solving the above-mentioned problems is characterized by that in the above-mentioned fourteenth or seventeenth invention, the power accumulating circuit is arranged in the interior of the lighting equipment.

A twenty-first invention for solving the above-mentioned problems is characterized by that in the above-mentioned fifteenth or eighteenth invention, the power accumulating circuit is arranged in the fluorescent lamp.

A twenty-second invention for solving the above-mentioned problems is characterized by that in the above-mentioned sixteenth or nineteenth invention, the power accumulating circuit is arranged in the ballast.

A twenty-third invention for solving the above-mentioned problems is a power supply circuit, which has a transmitting section sending power obtained from the internal circuit of the lighting equipment, by using electromagnetic induction, and an interface connecting a transmitter which sends a signal by using the power transmitted by the transmitting section, characterized by that the transmitting section is arranged to electrically insulate the lighting equipment and the interface from each other.

A twenty-fourth invention for solving the above-mentioned problems is a lighting system, which has a transmitting section transmitting power obtained from the internal circuit of the existing lighting equipment, by using electromagnetic induction, and an interface connecting an external electric appliance operated by using power obtained from the transmitting section, characterized by that the transmitting section electrically insulates the lighting equipment and the interface from each other.

A twenty-fifth invention for solving the above-mentioned problems is characterized by that in the above-mentioned twenty-fourth invention, the transmitting section comprises a transformer.

A twenty-sixth invention for solving the above-mentioned problems is characterized by that in the above-mentioned twenty-fourth or twenty-fifth invention, a rectifying circuit is provided to rectify the voltage supplied from the transmitting section.

A twenty-seventh invention for solving the above-mentioned problems is characterized by that in one of the above-mentioned twenty-fourth to the twenty-sixth inventions, the internal circuit is cable which connects the ballast and the fluorescent lamp, respectively provided in the lighting equipment, or a filament for preheating the fluorescent lamp mounted in the lighting equipment.

A twenty-eighth invention for solving the above-mentioned problems is characterized by that in one of the above-mentioned twenty-fourth to the twenty-seventh inventions, a voltage boosting circuit is provided to boost and output the voltage inputted from the transmitting section, to the interface.

A twenty-ninth invention for solving the above-mentioned problems is characterized by that in the above-mentioned twenty-eighth invention, the voltage boosting circuit has an operation controlling section which is only actuated when the impressed voltage meets a predetermined first condition, and a startup retarding circuit in which voltage meeting the first condition is applied to the operation controlling section after a predetermined period of time lapses commencing with the startup of the lighting equipment.

A thirtieth invention for solving the above-mentioned problems is characterized by that in one of the above-mentioned twenty-fourth to the twenty-ninth inventions, a power accumulating circuit is provided to accumulate current from the transmitting section, and to output the current as may be required.

A thirty-first invention for solving the above-mentioned problems is characterized by that in one of the above-mentioned twenty-fourth to thirtieth inventions, the transmitting section is connected such as to be in parallel with the preheating filament for the fluorescent lamp.

The present invention is a power supply circuit in which power is obtained from the cable connecting the ballast and the fluorescent lamp of the lighting equipment, or from the internal circuit of the lighting equipment, such as the preheating filament of the fluorescent lamp or the like, characterized by that the power supply circuit is electrically insulated from the lighting equipment to prevent any resulting effect upon the lighting equipment when electric leakage, short circuit or any other similar trouble has taken place on the external electric appliances connected to this power supply circuit.

### Effects of the Invention

A first effect of the present invention is that the introducing cost of technology which is capable of identifying the position of the indoor terminal with high accuracy can be reduced. This is feasible, because the power supply circuit providing the external appliance with power from the existing lighting equipment is electrically insulated from the lighting equipment, and for this reason, loss of power is reduced.

A second effect is that power can safely be obtained from the existing lighting equipment. That is because power is fed to the external appliance from the existing lighting equipment by using the power supply circuit which is electrically insulated.

A third effect is that the fluorescent lamp which is the existing lighting equipment is not affected in its service life. That is because the power supply circuit starts to operate after a constant period of time has elapsed commencing with the startup of operation of the lighting equipment, and this does not allow the power supply circuit to affect the operation of the fluorescent lamp when it lights up.

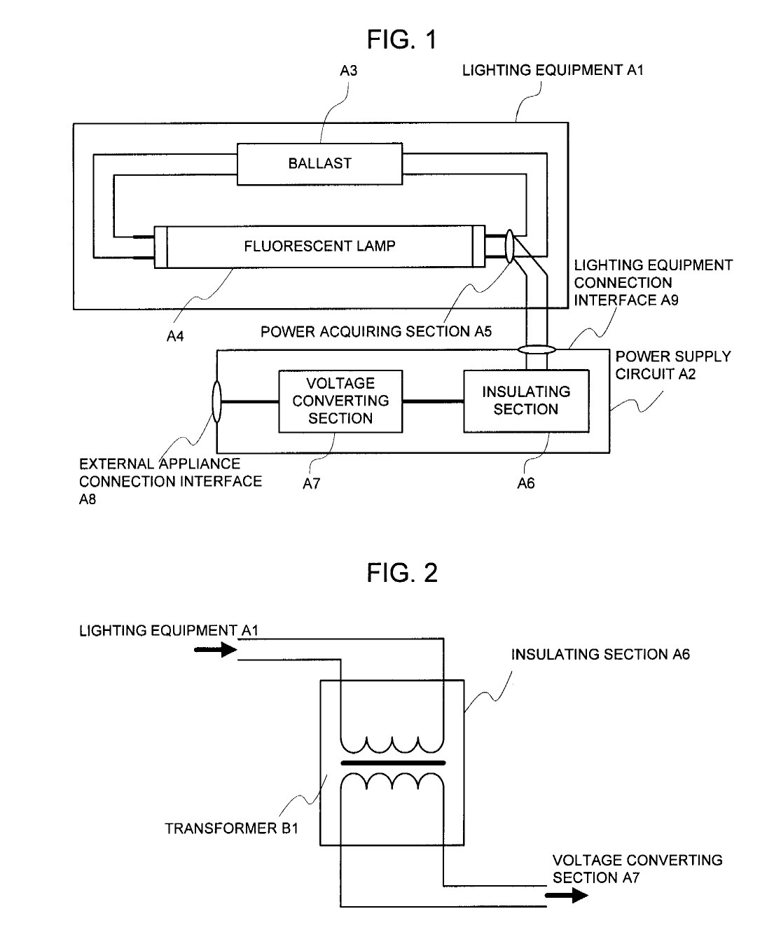

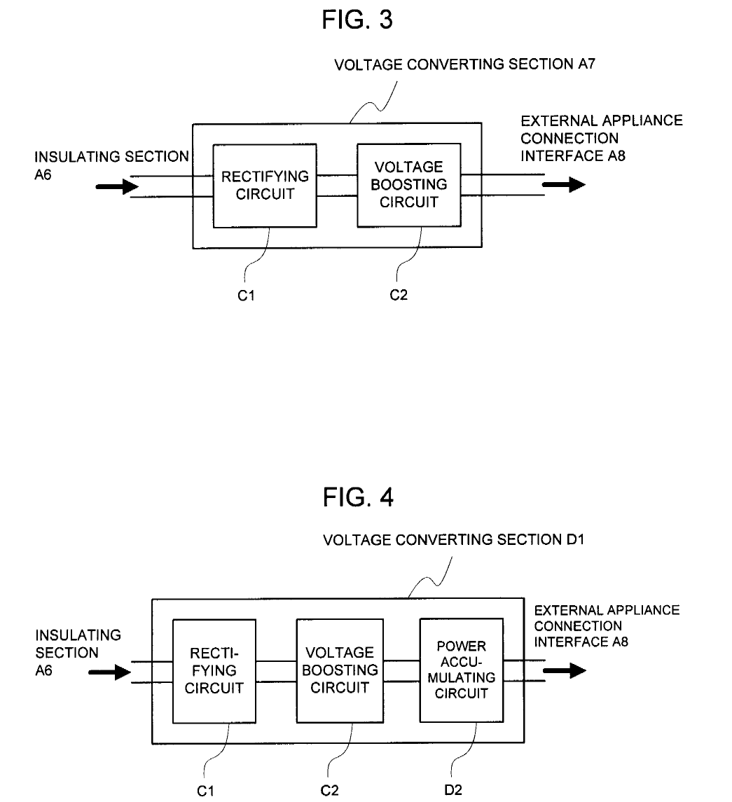

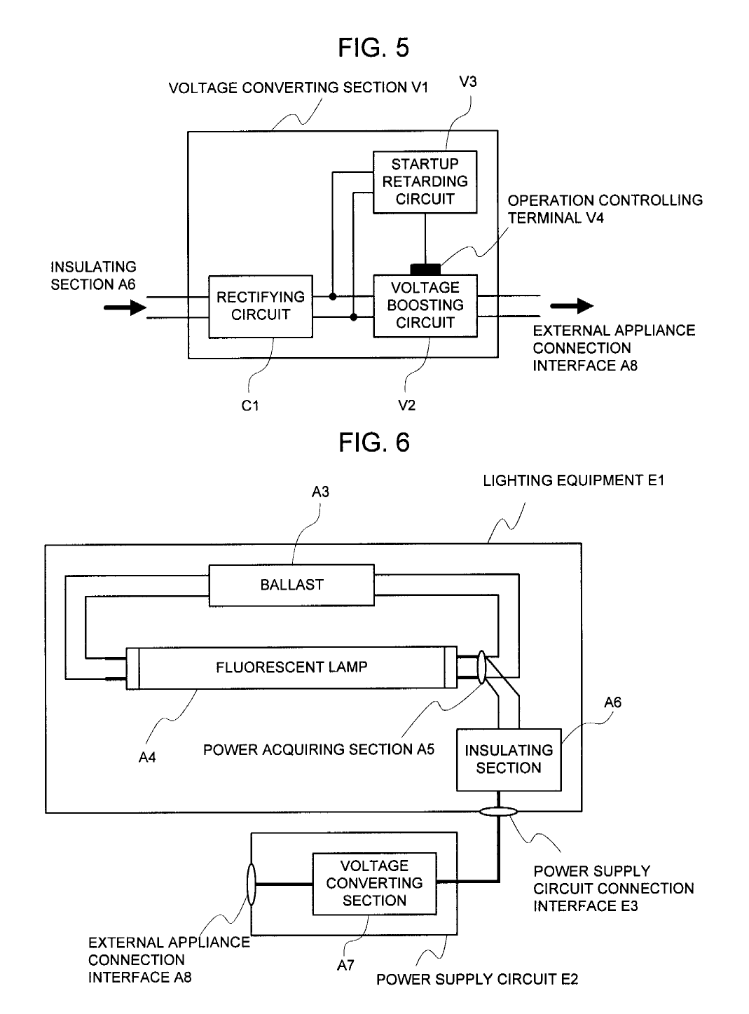

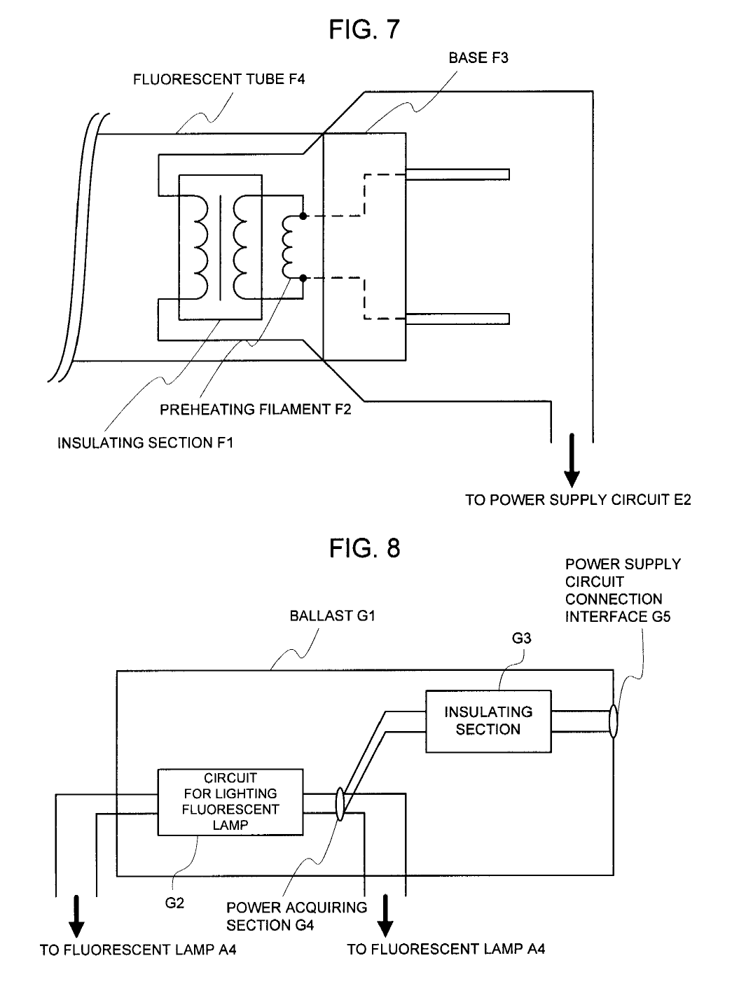

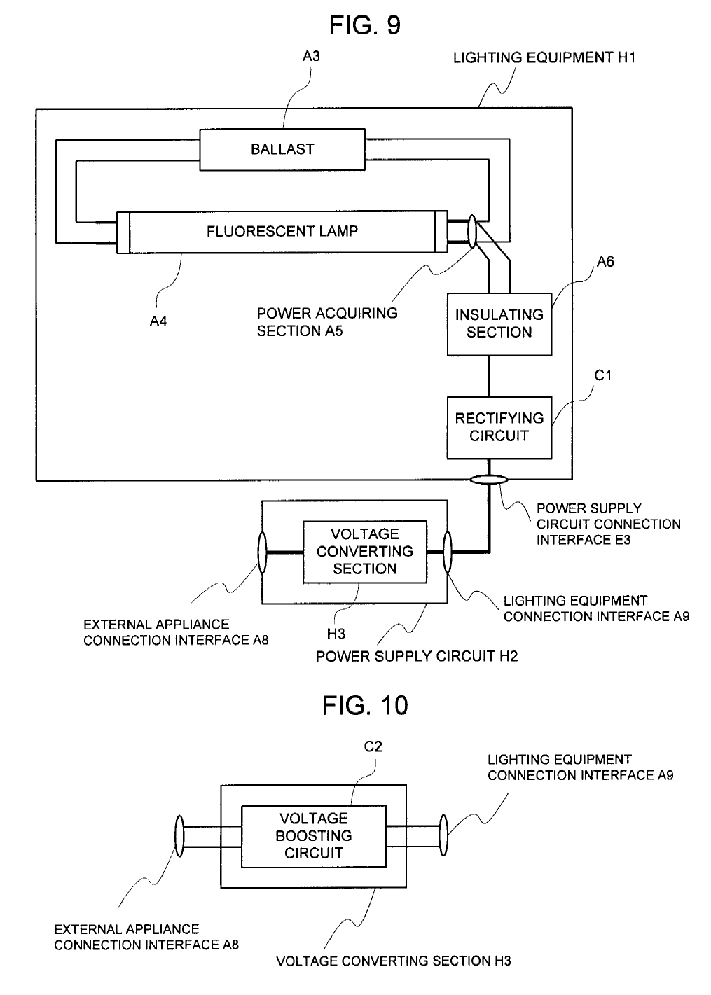

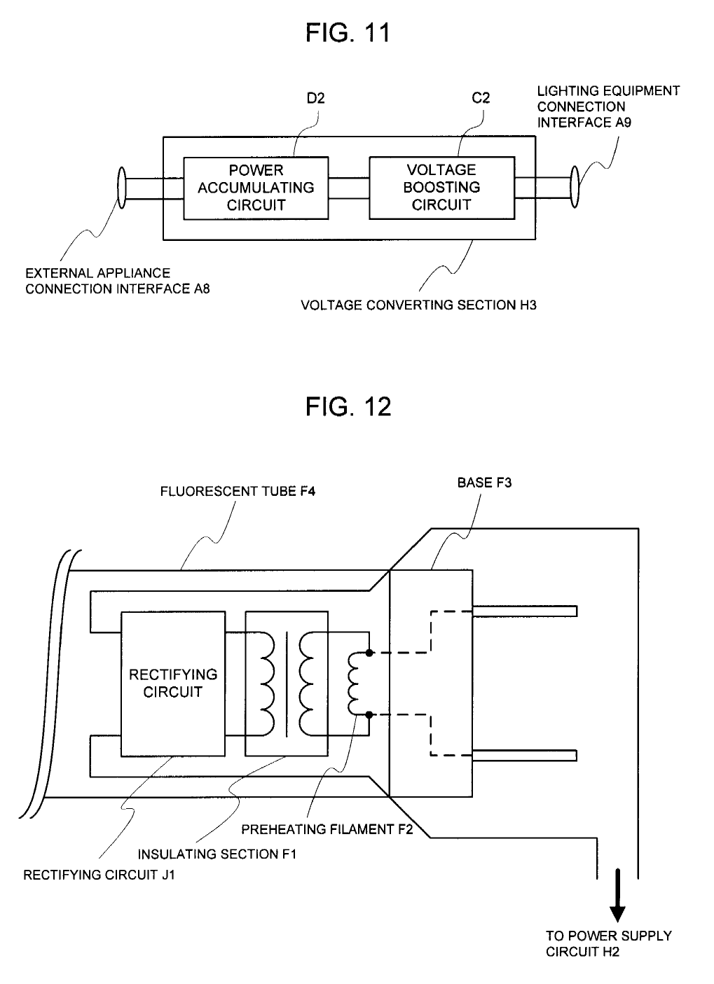

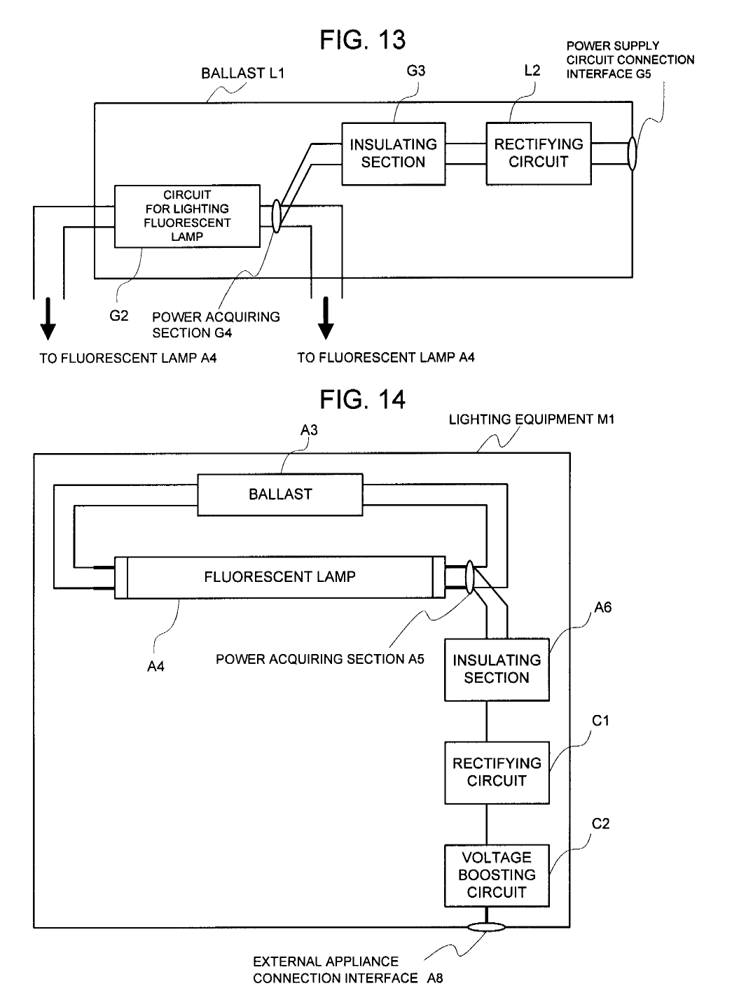

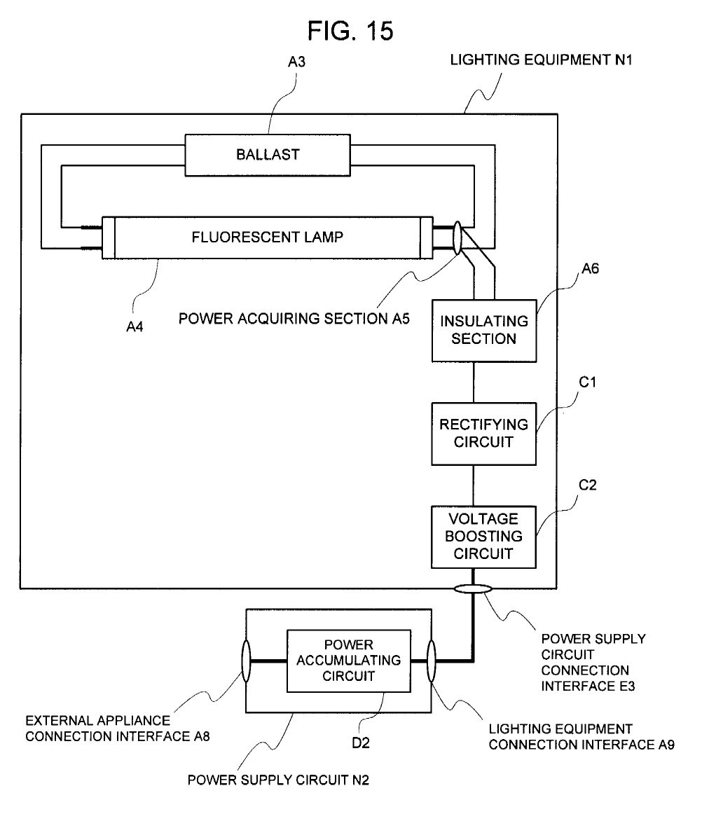

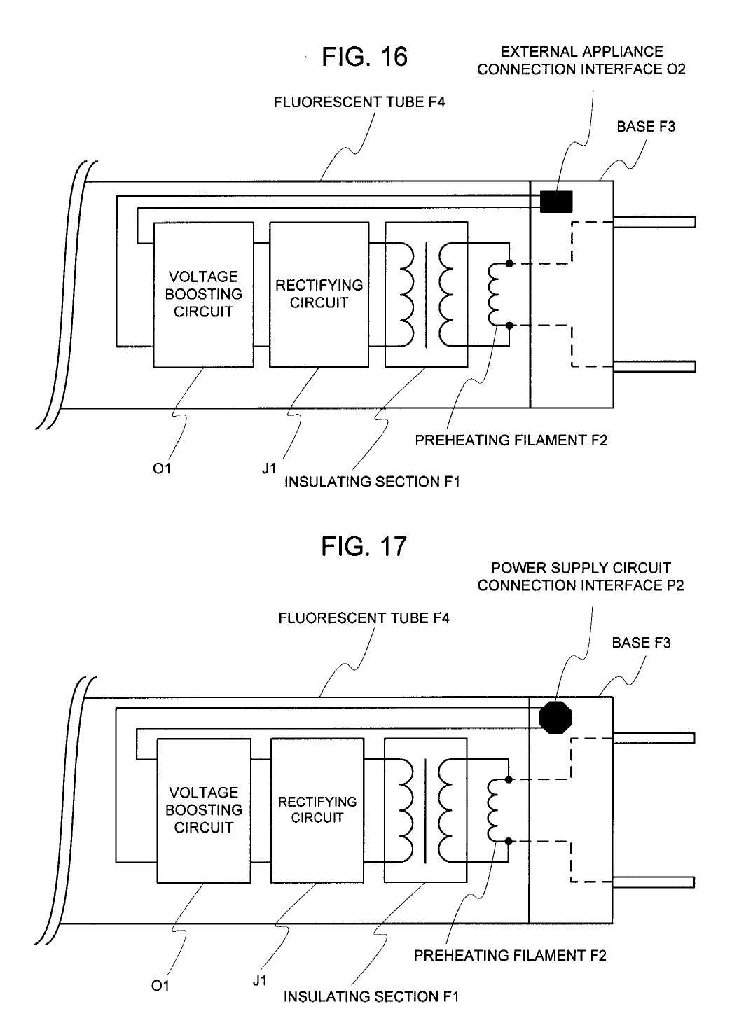

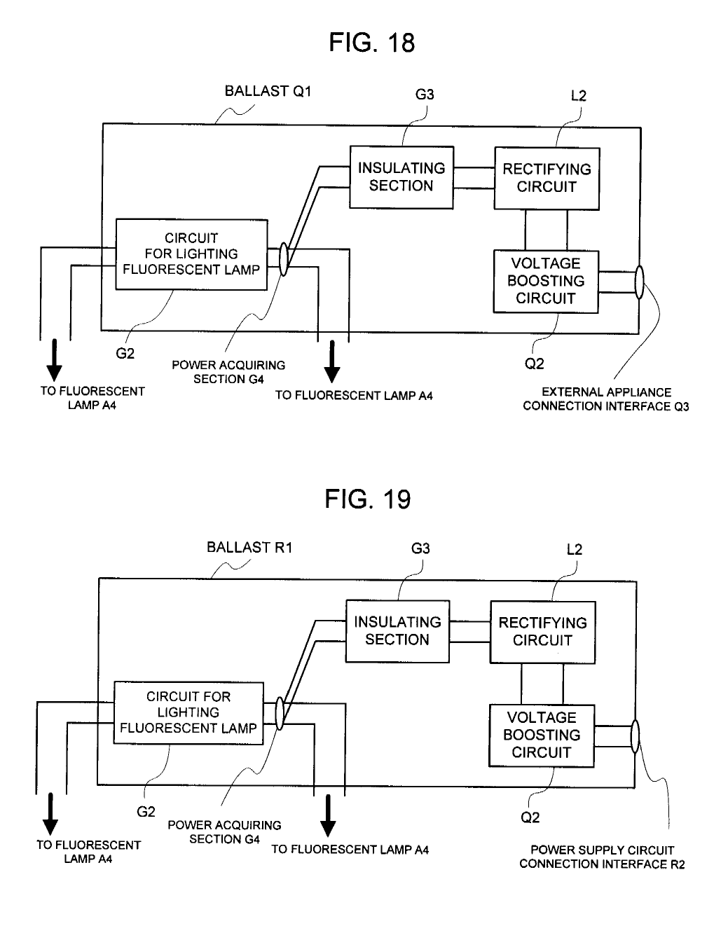

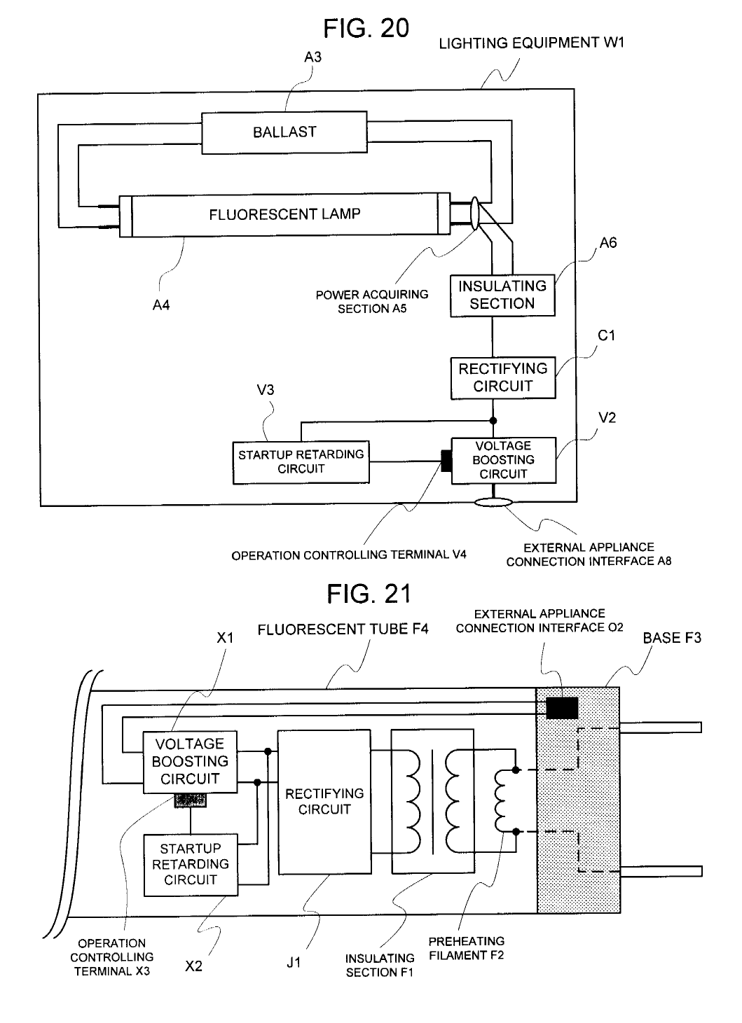

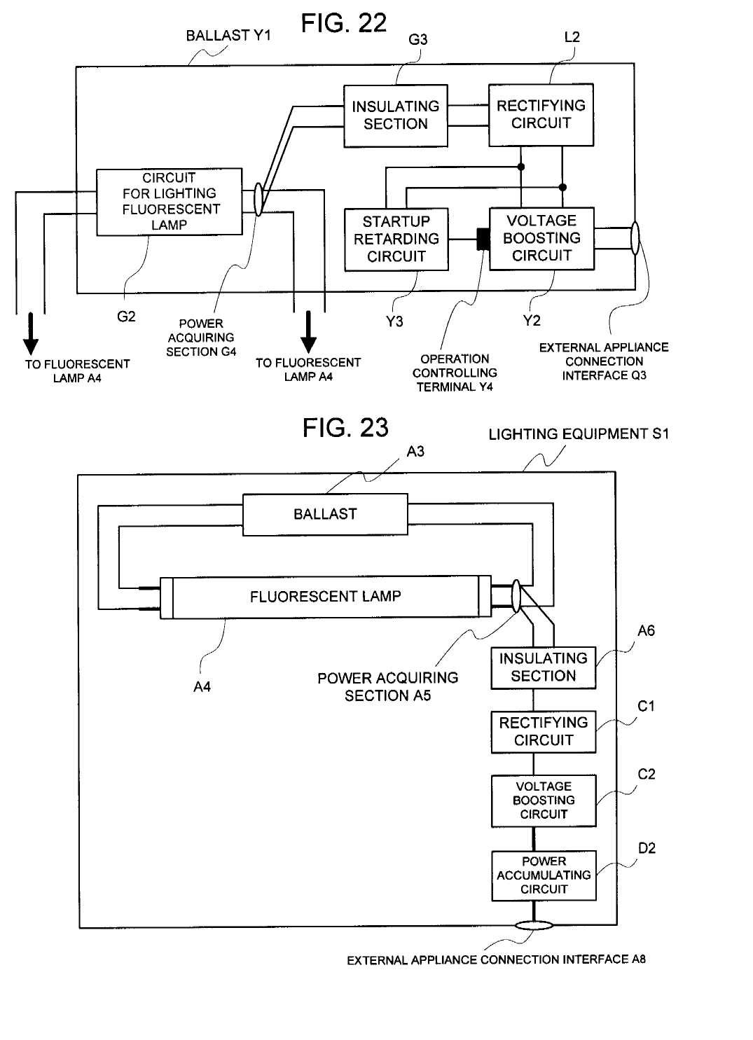

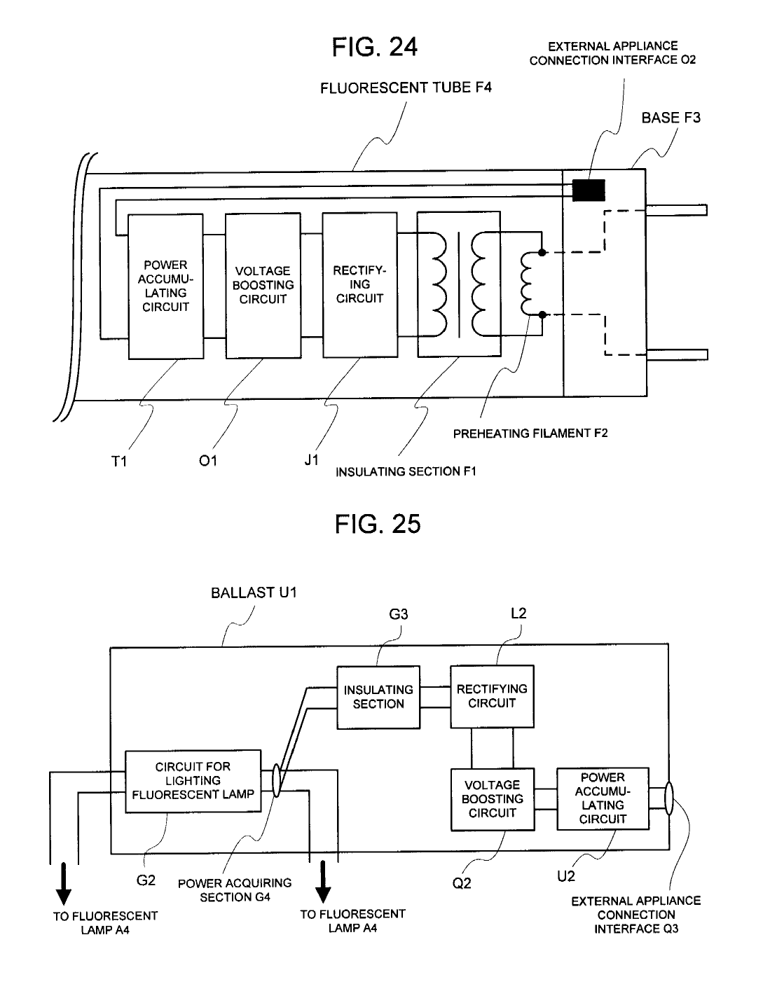

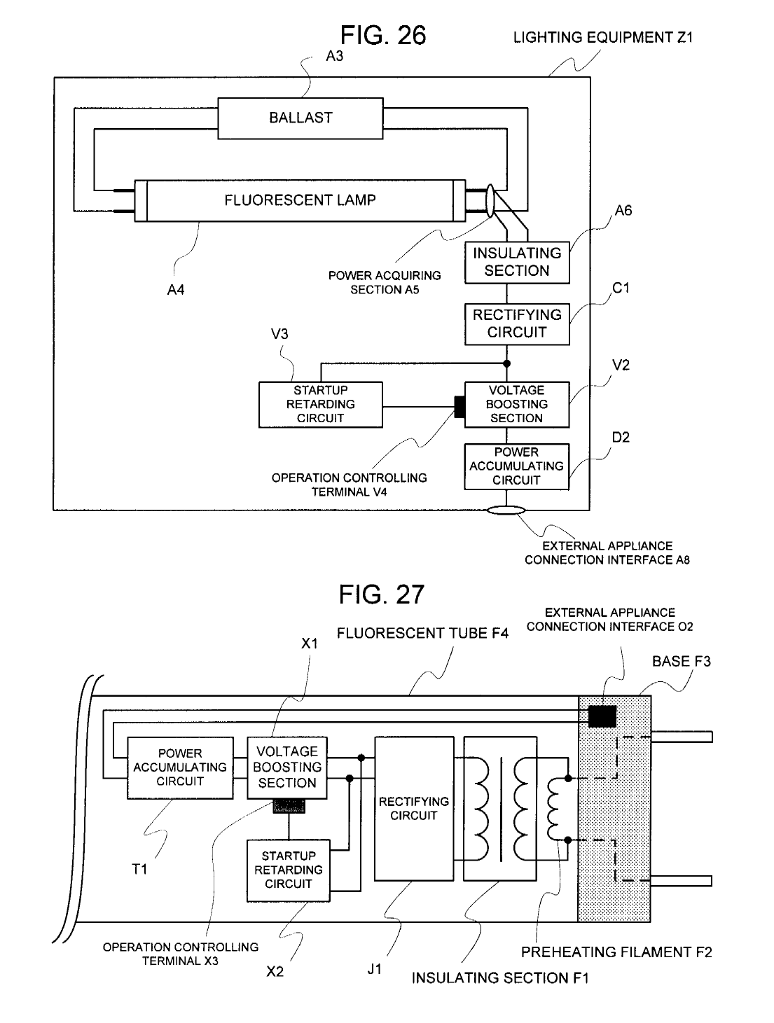

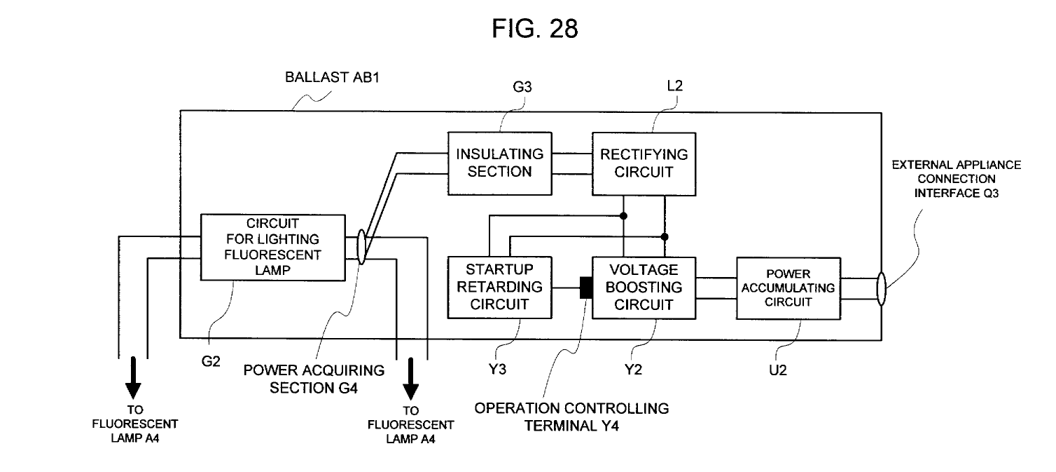

### BRIEF DESCRIPTION OF THE DRAWINGS

[FIG. 1] FIG. 1 is a block diagram of the lighting equipment and the power supply circuit in a first embodiment.

[FIG. 2] FIG. 2 is a diagram showing an example of the internal circuit of the insulating section A6.

[FIG. 3] FIG. 3 is a diagram showing an example of the internal circuit of the voltage converting section A7.

[FIG. 4] FIG. 4 is a diagram showing an example of the internal circuit of the voltage converting section D1 in the first embodiment.

[FIG. 5] FIG. 5 is a block diagram of the voltage converting section V1 in a modified example 2 of the first embodiment.

[FIG. 6] FIG. 6 is a block diagram of the lighting equipment E1 and the power supply circuit E2 in a second embodiment.

[FIG. 7] FIG. 7 is a diagram showing the construction of the fluorescent lamp in a modified example 1 of the second embodiment.

[FIG. 8] FIG. 8 is a block diagram of the ballast in a modified example 2 of the second embodiment.

[FIG. 9] FIG. 9 is a block diagram of the lighting equipment H1 and the power supply circuit H2 in a third embodiment.

[FIG. 10] FIG. 10 is a diagram showing the construction of the voltage converting section H3 in the third embodiment.

[FIG. 11] FIG. 11 is a diagram showing the construction of the voltage converting section H3 in a modified example 1 of the third embodiment.

[FIG. 12] FIG. 12 is a diagram showing the construction of the fluorescent lamp in a modified example 2 of the third embodiment.

[FIG. 13] FIG. 13 is a diagram showing the construction of the ballast L1 in a modified example 3 of the third embodiment.

[FIG. 14] FIG. 14 is a diagram showing the construction of a lighting equipment M1 in a fourth embodiment.

[FIG. 15] FIG. 15 is a diagram showing the construction of the lighting equipment N1 and the power supply circuit in a modified example 1 of the fourth embodiment.

[FIG. 16] FIG. 16 is a diagram showing the construction of the fluorescent lamp in a modified example 2 of the fourth embodiment.

[FIG. 17] FIG. 17 is a diagram showing the construction of the fluorescent lamp in the modified example 2 of the fourth embodiment.

[FIG. 18] FIG. 18 is block diagram of the ballast in a modified example 3 of the fourth embodiment.

[FIG. 19] FIG. 19 is a block diagram of the ballast in the modified example 3 of the fourth embodiment.

[FIG. 20] FIG. 20 is a block diagram of the lighting equipment W1 in a modified example 4 of the fourth embodiment.

[FIG. 21] FIG. 21 is a block diagram of the fluorescent lamp A4 in the modified example 4 of the fourth embodiment.

[FIG. 22] FIG. 22 is a block diagram of the ballast Y1 in the modified example 4 of the fourth embodiment.

[FIG. 23] FIG. 23 is a block diagram of the lighting equipment S1 in a fifth embodiment.

[FIG. 24] FIG. 24 is a block diagram showing the construction of the fluorescent lamp in a modified example 1 of the fifth embodiment.

[FIG. 25] FIG. 25 is a block diagram of the ballast U1 in a modified example 2 of the fifth embodiment.

[FIG. 26] FIG. 26 is a block diagram of the lighting equipment Z1 in a modified example 3 of the fifth embodiment.

[FIG. 27] FIG. 27 is a block diagram of the fluorescent lamp A4 in the modified example 3 of the fifth embodiment.

[FIG. 28] FIG. 28 is a block diagram of the ballast AB1 in the modified example 3 of the fifth embodiment.

### DESCRIPTION OF NUMERALS

A1, E1, H1, M1, N1, S1, W1 and Z1 Lighting Equipment

A2, E2, H2 and N2 Power Supply Circuit

A3, G1, L1, Q1, U1, Y1 and AB1 Ballast

A4 Fluorescent Lamp

A5 and G4 Power Acquiring Section

A6, F1 and G3 Insulating Section

A7, D1, H3 and V1 Voltage Converting Section

A8, O2 and Q3 External Appliance Connection Interface

A9 Lighting Equipment Connection Interface

B1 Transformer

C1, J1 and L2 Rectifying Circuit

C2, O1, Q2, V2, X1 and Y2 Voltage Boosting Circuit

D2, T1 and U2 Power Accumulating Circuit

E3, G5 and P2 Power Supply Circuit Connection Interface

F2 Preheating Filament

F3 Base

F4 Fluorescent Tube

V3, X2 and Y3 Startup Retarding Circuit

V4, X3 and Y4 Operation Controlling Terminal

### BEST MODE FOR EMBODYING THE INVENTION

The present invention is a power supply circuit in which power is acquired by using electromagnetic induction from the internal circuit of the lighting equipment, such as the cable for connecting the ballast and the fluorescent lamp of the lighting equipment, or the preheating filament of the fluorescent lamp and the like, characterized by electric insulation thereof from the lighting equipment to prevent any affect upon the lighting equipment, which may be caused by occurrence of electric leakage, short-circuit or any other similar trouble in the external electric appliances connected to this power supply circuit.

### First Embodiment

A mode in which the invention is embodied will now be described in detail by reference to the accompanying drawings.

FIG. 1 is a block diagram of the lighting system according to the present invention, which shows the connection of the lighting equipment A1 and the power supply circuit A2.

A lighting equipment A1 is provided with a ballast A3 and a fluorescent lamp A4. The ballast A3 and the fluorescent lamp A4 are connected to each other, and the ballast A3 impresses a sufficient amount of voltage to allow the fluorescent lamp to light up. The fluorescent lamp A4 lights up by using the voltage applied by the ballast A3.

The power supply circuit A2 is provided with an insulating section A6 and a voltage converting section A7, and is connected to a power acquiring section A5 through a lighting equipment connection interface A9. The power acquiring section A5 acquires power from the cable which connects the ballast and the fluorescent lamp of the lighting equipment A1. The insulating section A6 electrically isolates the lighting equipment A1 and the power supply circuit A7.

An external appliance connection interface A8 has a variety of electric appliances connected thereto. In this embodiment, an electric appliance connected through the external appliance connection interface A8 is presumed to be an infrared emitter, a Bluetooth transmitter, an RFID transmitter or any other similar transmitting device which sends a weak electric wave to identify the position of a terminal.

FIG. 2 is an example of the internal circuit of the insulating section A6.

The insulating section A6 comprises a transformer B1. The transformer B1 is an insulating transformer which has a turn ratio of 1:1, and sends power acquired by the power acquiring section A5 from the lighting equipment A1 to the voltage converting section A7 through electromagnetic induction. The voltage converting section A7 and the lighting equipment A1 are electrically insulated from each other.

FIG. 3 is an example of the internal circuit of the voltage converting section A7.

The voltage converting section A7 is provided with a rectifying circuit C1 and a voltage boosting circuit C2. The rectifying circuit C1 rectifies the voltage acquired by the power acquiring section A5 from the lighting equipment A1. The voltage boosting circuit C2 increases any obtained voltage to the voltage required by the electric appliance connected to the external appliance connection interface A8.

The electric appliance connected through the external appliance connection interface A8 uses the voltage increased by the voltage boosting circuit C2.

### Modified Example 1

The external appliance connection interface A8 may be connected to an electric appliance which momentarily needs great current when it starts to operate although it requires small mean driving power to such a degree that it can be sufficiently driven by the current provided by the power supply circuit A2. In this case, according to the required magnitude of the current, the power supply circuit A2 in the first embodiment occasionally can not meet the requirement in the magnitude of the current.

FIG. 4 is a diagram which shows an example of the internal circuit of the voltage converting section D1 in the present modified example.

The voltage converting section D1 is provided with a rectifying circuit C1, a voltage boosting circuit C2, and a power accumulating circuit D2.

The rectifying circuit C1, and the voltage boosting circuit C2 are the same as in the above-mentioned embodiment. Therefore, they are furnished with the same reference numerals, and any detailed description is omitted for them.

The power accumulating circuit D2 comprises, for example, a condenser. It accumulates electric charge while an electric appliance externally connected does not need any great current. Therefore, when an electric appliance connected to the external appliance connection interface A8 requires a great amount of current, the power accumulating circuit D2 discharges the electric charge accumulated therein to allow the supply of current to the electric appliance.

### Modified Example 2

When the fluorescent lamp A4 lights up, the filament for discharging thermoelectrons, which is located within the fluorescent lamp A4 is quickly heated from the ballast A3, a greater amount of current flows than usual. In this case, when the power supply circuit A2 takes power, the discharge of the thermoelectrons is started before the filament is sufficiently increased in its temperature, and there is the risk that the fluorescent lamp A4 is adversely affected in its effective life.

As a method of solving this problem, conceivable is a way in which the voltage converting section A7 is retarded in its start-up. In this modified example, the voltage converting section A7 is varied in its arrangement for that purpose.

FIG. 5 is a diagram which shows an arrangement of the voltage converting section V1 according to this modified example.

The voltage converting section V1 is provided with a rectifying circuit C1, a voltage boosting circuit V2, and a startup retarding circuit V3. The rectifying circuit C1 is the same as the above-mentioned first embodiment, and any detailed description of the rectifying circuit C1 is omitted.

The voltage boosting circuit V2 is provided with an operation controlling terminal V4, and does not operate when the operation controlling terminal V4 does not have any voltage applied thereto which is greater than predetermined.

The startup retarding circuit V3 impresses specified voltage to the operation controlling terminal V4 after a period of predetermined time elapsed commencing with an application of voltage from the rectifying circuit C1. This allows the startup of the voltage boosting circuit V2 to become late by predetermined time from the start up of the lighting equipment A1, and as a result, the startup of the voltage converting section V1 can be retarded. The predetermined time cited in the foregoing may be freely set to such a degree that the fluorescent lamp A4 is not adversely affected in its service life.

The voltage boosting circuit V2 may be arranged so that it does not operate when less voltage than specified is only impressed on the operation controlling terminal V4 or so that the voltage boosting circuit V2 operates only when it receives a certain pattern of controlling signal. When the startup retarding circuit V3 is arranged according to either of these arranging methods of the voltage boosting circuit, the voltage converting section V1 can be retarded in its startup.

Also, in this modified example, the explained operation of the voltage boosting circuit V2 is such that the voltage converting section A7 is loaded with the startup retarding circuit V3. However, the same effect can be obtained by arranging such that the voltage boosting circuit C2 of the voltage converting section D1 is changed to the voltage boosting circuit V2, and the startup retarding circuit V3 is added.

### Second Embodiment

In the above-mentioned first embodiment, explanation is carried out an arrangement in which the lighting equipment A1 has the power supply circuit A2 connected outside thereof, and the insulating section A6 functions as the internal circuit of the power supply circuit A2. In this embodiment, explained is the arrangement in which the insulating section A6 is located within the lighting equipment A1.

FIG. 6 is a diagram which shows the connection of the lighting equipment E1 and the power supply circuit E2 in this embodiment.

A lighting equipment E1 is provided with the ballast A3, the fluorescent lamp A4, and the insulating section A6, and is connected to the power supply circuit E2 through the power supply circuit connection interface E3. The ballast A3, the fluorescent lamp A4, and the insulating section A6 are the same as in the first embodiment, and therefore, their description is omitted.

The power supply circuit E2 comprises the voltage converting section A7, and is connected to the external appliance through the external appliance connection interface A8.

### Modified Example 1

In this embodiment, the insulating section may be integrated with the fluorescent lamp into a single unit relation. Therefore, in this modified example, description is made on an arrangement in which the insulating section and the fluorescent lamp are joined into a single unit relation.

FIG. 7 is a diagram which shows the fluorescent lamp is united with the insulating section into a single unit relation.

The fluorescent lamp internally has the preheating filament F2, and the insulating section F1 is connected in parallel with this preheating filament F2. In this modified example, the insulating section F1 is arranged such that it comprises the insulating transformer as an example.

The cable for connecting the insulating section F1 and the power supply circuit E2 is taken out from between the fluorescent tube F4 and the base F3 of the fluorescent lamp.

### Modified Example 2

In this embodiment, the insulating section may be integrated with the ballast into a single unit relation. Therefore, in this modified example, description is made on an arrangement in which the insulating section is integrated with the ballast into a single unit relation.

FIG. 8 is a block diagram of the function of the ballast G1 united with the insulating section into a single unit relation.

The ballast G1 is provided with a circuit G2 for lighting the fluorescent lamp, and the insulating section G3. The insulating section G3 is connected to the fluorescent lamp A4 in parallel therewith through the power acquiring section G4. Moreover, the insulating section G3 is connected to the power supply circuit E2 through the power supply circuit connection interface G5.

### Third Embodiment

In the above-mentioned second embodiment, description is made on an arrangement in which the lighting equipment E2 has the insulating section A6 located therein. In this embodiment, the rectifying circuit C1 which constitutes the voltage converting section A7 is also located within the lighting equipment, and this arrangement is now described.

FIG. 9 is a diagram which shows the connection of the lighting equipment H1 and the power supply circuit H2 in this embodiment.

The lighting equipment H1 is provided with the ballast A3, the fluorescent lamp A4, the insulating section A6, and the rectifying circuit C1. These components have the same functions as in the above-mentioned first embodiment, and their detailed description is omitted.

FIG. 10 is a diagram which shows an arrangement of the voltage converting section H3 in this embodiment.

The voltage converting section H3 is provided with the voltage boosting circuit C2. The voltage boosting circuit C2 has the same function as in the first embodiment, and their detailed description is omitted.

### Modified Example 1

The external appliance connection interface A8 can have an electric appliance connected thereto which momentarily needs great current when it starts to operate although it only requires small mean driving power to such a degree that it can be sufficiently driven by the power supply circuit H2. In this case, according to the necessary magnitude of the current through the electric appliance connected to the interface 8, the power supply circuit H2 occasionally can not provide the current of a necessary magnitude. Therefore, in this modified example, description is made on an arrangement in which the voltage converting section comprises a power accumulating circuit.

FIG. 11 is a diagram which shows an example of the internal circuit of the voltage converting section H3 in this modified example.

The voltage converting section H3 is provide with the voltage boosting circuit C2 and the power accumulating circuit D2. The voltage boosting circuit C2 and the power accumulating circuit D2 have the same functions as in the first embodiment, and their detailed description is omitted.

### Modified Example 2

In this embodiment, the insulating section A6 and the rectifying circuit C2 may be integrated with the fluorescent lamp A4 into a single unit relation. Therefore, description is made on an arrangement in which the insulating section A6 and the rectifying circuit C2 are united with the fluorescent lamp A4 into a single unit relation in this modified example.

FIG. 12 is a diagram which shows the arrangement of the fluorescent lamp in this modified example.

The fluorescent lamp is provided with the preheating filament F2 in its interior, and the insulating section F1 is connected to the preheating filament F2 in parallel therewith. In this modified example, the insulating section F1 comprises the transformer as an example.

The rectifying circuit J1 is connected to the insulating section F1, and rectifies the voltage acquired from the insulating section F1. The cable which connect the rectifying circuit J1 and the power supply circuit H2 is taken out from the spacing between the fluorescent tube F4 and the base F3 of the fluorescent lamp.

### Modified Example 3

In this embodiment, the insulating section and the rectifying circuit may be united with the ballast into a single unit relation. Therefore, in this modified example, description is made on an arrangement in which the insulating section and the rectifying circuit are integrated with the ballast into a single unit relation.

FIG. 13 is an arrangement diagram of this modified example as well as a block diagram of function of the ballast L1 integrated with the insulating section and the rectifying circuit into a single unit relation.

The ballast L1 is provided with the circuit G2 for lighting the fluorescent lamp, the insulating section G3, and the rectifying circuit L2. The insulating section G3 is connected to the fluorescent lamp A4 through the power acquiring section G4 in parallel with the fluorescent lamp A4. The rectifying circuit L2 is connected to the power supply circuit H2 through the power supply circuit connection interface G5.

### Fourth Embodiment

In the above-mentioned third embodiment, description is made on an arrangement in which the lighting equipment H1 has the insulating section A6 and the rectifying circuit C1 located therein. In this embodiment, description is carried out upon an arrangement in which the voltage boosting circuit C2 comprising the voltage converting section H3 is also located in the interior of the lighting equipment.

FIG. 14 is diagram which shows an arrangement of the lighting equipment M1 in this embodiment.

The lighting equipment M1 is provided with the ballast A3, the fluorescent lamp A4, the insulating section A6, and the rectifying circuit C1, and the voltage boosting circuit C2. These components are respectively identical in their functions to those in the first embodiment, and therefore, their detailed description is omitted.

### Modified Example 1

The external appliance connection interface A8 may have an electric appliance connected thereto, which momentarily needs a great current when it starts to operate although it only requires small mean driving power. In this case, according to the required current to start the operation of the external appliance, this embodiment occasionally can not meet the requirement in the magnitude of the current at the time of the starting operation of the external appliance. Therefore, in this modified example, description is carried out upon an arrangement in which a power accumulating circuit is provided.

FIG. 15 is a diagram which shows an arrangement of the lighting equipment N1 and the power supply circuit N2 in this modified example.

The power supply circuit N2 is provided with the power accumulating circuit D2. The power accumulating circuit D2 has the same function as in the first embodiment, and therefore, its detailed description is omitted.

### Modified Example 2

The insulating section A6, the rectifying circuit C1, and the voltage boosting circuit C2 may be united with the fluorescent lamp A4 into a single unit relation. Therefore, in this modified example, explanation is made on an arrangement in which the insulating section, the rectifying circuit and the voltage boosting circuit are integrated with the fluorescent lamp into a single unit relation.

FIG. 16 is a diagram which shows the construction of the fluorescent lamp in this modified example.

The fluorescent lamp internally has the preheating filament F2, and the insulating section F1 is connected in parallel with the preheating filament F2. In this modified example, the insulating section F1 is formed by the transformer as an example, and this arrangement is described.

The rectifying circuit J1 is connected to the insulating section F1 to rectify the voltage acquired from the insulating section F1. Also, the rectifying circuit J1 is connected to the voltage boosting circuit O1, and the voltage boosting circuit O1 boosts the voltage supplied from the rectifying circuit J1, to the voltage required by the appliance externally connected. Thus, the boosted voltage is fed to the external appliance through the external appliance connection interface O2.

Also, as in the modified example 1 of this embodiment, an arrangement in which the power supply circuit N2 is connected to the fluorescent lamp may be also used.

FIG. 17 is a diagram which shows a construction of the fluorescent lamp which has the power supply circuit N2 connected thereto.

When the power supply circuit N2 is connected to the fluorescent lamp, the voltage boosting circuit O1 is joined to the power supply circuit N2 through the power supply circuit connection interface P2.

### Modified Example 3

In this embodiment, the insulating section, the rectifying circuit, and the voltage boosting circuit can be united with the ballast into a single unit relation. Therefore, in this modified example, description is carried out upon an arrangement in which the insulating section, the rectifying circuit, and the voltage boosting circuit are integrated with the ballast into a single unit relation.

FIG. 18 is a block diagram of the ballast Q1 integrated with the insulating section, the rectifying circuit, and the voltage boosting circuit into a single unit relation.

The ballast Q1 is provided with the circuit G2 for lighting the fluorescent lamp, the insulating section G3, the rectifying circuit L2, and the voltage boosting circuit Q2. The insulating section G3 is connected in parallel with the fluorescent lamp A4 through the power acquiring section G4. The voltage boosting circuit Q2 is connected to the rectifying circuit L2, and boosts the output voltage of the rectifying circuit L2 to the voltage required by the external appliance. The voltage boosting circuit Q2 is connected to the external appliance through the external appliance connection interface Q3.

Also, as described in the modified example 1 of this embodiment, the power supply circuit N2 may be arranged to be connected.

FIG. 19 shows a diagram which shows construction of the ballast R1 when the power supply circuit N2 is connected.

When the power supply circuit N2 is connected, the voltage boosting circuit Q2 is connected to the power supply circuit N2 through the power supply circuit connection interface R2.

### Modified Example 4

In this embodiment and the modified examples 1 to 3 in this embodiment, description is made on an arrangement in which the rectifying circuit and the voltage boosting circuit are united with the lighting equipment, the fluorescent lamp, and the ballast into a single unit relation. However, as described in the modified example 2 of the first embodiment, the startup retarding circuit may be joined with the lighting equipment, the fluorescent lamp, and the ballast into a single unit relation.

FIG. 20 is a diagram which shows an arrangement of the lighting equipment W1 in this modified example.

The lighting equipment W1 is provided with the ballast A3, the fluorescent lamp A4, the insulating section A6, the rectifying circuit C1, the voltage boosting circuit V2, and the startup retarding circuit V3. These components respectively have the same functions as described in the first embodiment, and therefore, their detailed description is omitted.

In this modified example, the voltage boosting circuit V2 is connected to the external appliance through the external appliance connection interface. However, as in the modified example 2, it may be arranged that the power supply circuit N2 is connected by changing the connection interface.

Also, as in the modified example 2, the voltage boosting circuit V2 may be united with the fluorescent lamp A4 into a single unit relation.

FIG. 21 is a diagram which shows construction of the fluorescent lamp A4 in this modified example.

The fluorescent lamp A4 is provided with the insulating section F1, the rectifying circuit J1, the voltage boosting circuit X1, and the startup retarding circuit X2. These components respectively have the same functions as in the first embodiment, and their detailed description is therefore omitted.

Also, as in the modified example 2, it may be arranged that the power supply circuit N2 is connected by changing the connection interface.

Also, the unification with the ballast A3 as in the modified example 3 is also feasible.

FIG. 22 is a diagram which shows construction of the ballast in this modified example.

The ballast Y1 is provided with the circuit G2 for lighting the fluorescent lamp, the insulating section G3, the rectifying circuit L2, the voltage boosting circuit Y2, and the startup retarding circuit Y3. These components respectively have the same functions as in the first embodiment, and therefore, their detailed description is omitted.

Also, as in the modified example 2, it may be arranged that the power supply circuit N2 is connected by changing the connection interface.

### Fifth Embodiment

In the modified example 1 of the fourth embodiment, the described arrangement is such that the lighting equipment has the insulating section, the rectifying circuit and voltage boosting circuit located therein, and the power accumulating circuit is externally positioned as the power supply circuit. In this embodiment, description is made on an arrangement that the power accumulating circuit is located internally of the lighting equipment.

FIG. 23 is a block diagram which shows the function of the lighting equipment S1 which has the power accumulating circuit D2 located therein.

The lighting equipment S1 is provided with the ballast A3, the fluorescent lamp A4, the insulation section A6, the rectifying circuit C1, the voltage boosting circuit C2, and the power accumulating circuit D2. These components respectively have the same functions as in the above-mentioned first embodiment. Therefore, their detailed description is omitted.

### Modified Example 1

In this embodiment, the insulating section A6, the rectifying circuit C1, the voltage boosting circuit C2, and the power accumulating circuit D2 may be integrated with the fluorescent lamp A4 into a single unit relation. Therefore, in this modified example, description is made on an arrangement in which the insulating section A6, the rectifying circuit C1, the voltage boosting circuit C2, and the power accumulating circuit D2 are integrated with the fluorescent lamp A4 into a single unit relation.

FIG. 24 is a diagram which shows construction of the fluorescent lamp in this modified example.

The fluorescent lamp has the preheating filament F2 located therein, and the insulating section F1 is connected in parallel with this preheating filament F2. In this modified example, the insulating section F1 comprises a transformer as a example.

The rectifying circuit J1 is connected to the insulating section F1, and rectifies the voltage acquired from the insulating section F1. Also, the rectifying circuit J1 is connected to the voltage boosting circuit O1, and the voltage boosting circuit O1 increases the voltage supplied from the rectifying circuit J1 to the voltage required by the appliance externally connected. The power accumulating circuit T1 is connected to the voltage boosting circuit. This power accumulating circuit T1 which is connected to voltage boosting circuit accumulates current while any large current is not needed by the external appliance, and when large current is required by the external appliance, it outputs its accumulated current to the external appliance through the external appliance connection interface O2.

### Modified Example 2

In this embodiment, the insulating section, the rectifying circuit, the voltage boosting circuit, and the power accumulating circuit may be integrated with the ballast into a single unit relation. Therefore, in this modified example, description is made on an arrangement in which the insulating section, the rectifying circuit, the voltage boosting circuit, and the power accumulating circuit may be united with the ballast into a single unit relation.

FIG. 25 is a block diagram which represents the function of the ballast U1 integrated with the insulating section, the rectifying circuit, the voltage boosting circuit, and the power accumulating circuit into a single unit relation.

The ballast U1 is provided with the circuit G2 for lighting the fluorescent lamp, the insulating section G3, the rectifying circuit L2, the voltage boosting circuit Q2, and the power accumulating circuit U2. The insulating section G3 is connected in parallel with the fluorescent lamp A4 through the power acquiring section G4. The voltage boosting circuit Q2 is connected to the rectifying circuit L2 to increase the output voltage of the rectifying circuit L2 to the voltage required by the external appliance. The power accumulating circuit U2 is connected to the voltage boosting circuit Q2. This power accumulating circuit accumulates current while any large current is not needed by the external appliance, and when large current is required by the external appliance, it outputs its accumulated current to the external appliance through the external appliance connection interface Q3.

### Modified Example 3

In this embodiment and the modified examples 1 and 2 of this embodiment, description is made on an arrangement in which the rectifying circuit, the voltage boosting circuit, and the power accumulating circuit are integrated with the lighting equipment, the fluorescent lamp, and the ballast into a single unit relation. In this modified example 3, description is carried out upon an arrangement in which the startup retarding circuit may be joined with the lighting equipment, the fluorescent lamp, and the ballast into a single unit relation as in the startup retarding circuit described in the modified example 2 of the first embodiment.

FIG. 26 is a diagram which shows an arrangement of the lighting equipment Z1 in this modified example.

The lighting equipment Z1 is provided with the ballast A3, the fluorescent lamp A4, the insulating section A6, the rectifying circuit C1, the voltage boosting circuit V2, the startup retarding circuit V3, and the power accumulating circuit D2. These components are identical in their respective functions to those in the first embodiment, and therefore, the detailed description of the components is omitted.

Also, as in the modified example 1, the insulating section, the rectifying circuit, the voltage boosting circuit, the startup retarding circuit, and the power accumulating circuit may be integrated with the fluorescent lamp A4 into a single unit relation.

FIG. 27 is a diagram which shows construction of the fluorescent lamp A4 in this modified example.

The fluorescent lamp A4 comprises the insulating section F1, the rectifying circuit J1, the voltage boosting circuit X1, the startup retarding circuit X2, and the power accumulating circuit T1. These components respectively have the same functions as in the first embodiment, and therefore, their detailed description is omitted.

Also, it may be arranged that the power supply circuit N2 is connected by changing the connection interface as in the modified example 2.

Also, the integration with the ballast A3 may be feasible as in the modified example 2.

FIG. 28 is a diagram which shows construction of the ballast in this modified example.

The ballast AB1 is provided with the circuit G2 for lighting the fluorescent lamp, the insulating section G3, the rectifying circuit L2, the voltage boosting circuit Y2, the startup retarding circuit Y3, and the power accumulating circuit U2. These components respectively have the same functions as in the first embodiment, and their detailed description is omitted.

Also, it may be arranged that the power supply circuit N2 is connected by changing the connection interface as in the modified example 2.

1-31. (canceled)

32. A power supply circuit connected to a lighting equipment comprising a fluorescent lamp and a ballast which lights this fluorescent lamp, and acquiring power from the internal circuit of this lighting equipment, characterized by that an insulating section is provided which electrically isolates said internal circuit, and said insulating section is connected in parallel with a preheating filament within said fluorescent lamp.

33. A power supply circuit according to claim 32, characterized by that said insulating section comprises a transformer.

34. A power supply circuit according to claim 32, characterized in comprising:
a rectifying circuit which rectifies and outputs inputted voltage;
an interface which is connectable to said lighting equipment; and
an interface which is connectable to an external electric appliance.

35. A power supply circuit according to claim 32, characterized in comprising:
a voltage boosting circuit which increases and outputs inputted voltage;
an interface which is connectable to said lighting equipment; and
an interface which is connectable to an external electric appliance.

36. A power supply circuit according to claim 35, characterized by that said voltage boosting circuit is provided with:
an operation controlling section operates only when impressed voltage meets a predetermined first condition;
a startup retarding circuit which is connected to said operation controlling section, and applies to said operation controlling section voltage which meets said first condition after predetermined time elapses commencing with the startup of said lighting equipment.

37. A power supply circuit according to claim 34, characterized in comprising a power accumulating circuit which accumulates inputted current, and outputs it according to necessity.

38. A power supply circuit according to claim 35, characterized in comprising a power accumulating circuit which accumulates inputted current, and outputs it according to necessity.

39. A power supply circuit according to claim 32, characterized by that said insulating section is arranged internally of said lighting equipment.

40. A power supply circuit according to claim 32, characterized by that said insulating section is arranged in said fluorescent lamp.

41. A power supply circuit according to claim 32, characterized by that said insulating section is arranged in said ballast.

42. A power supply circuit according to claim 39, characterized by a rectifying circuit which rectifies and outputs inputted voltage is arranged within said lighting equipment.

43. A power supply circuit according to claim 40, characterized by a rectifying circuit which rectifies and outputs inputted voltage is arranged in said fluorescent lamp.

44. A power supply circuit according to claim 41, characterized by that a rectifying circuit which rectifies and outputs inputted voltage is arranged in said ballast.

45. A power supply circuit according to claim 42, characterized by that a voltage boosting circuit which increases and outputs inputted voltage is arranged within said lighting equipment.

46. A power supply circuit according to claim 43, characterized by that a voltage boosting circuit which increases and outputs inputted voltage is arranged in said fluorescent lamp.

47. A power supply circuit according to claim 44, characterized by that a voltage boosting circuit which increases and outputs inputted voltage is arranged in said ballast.

48. A power supply circuit according to claim 45, characterized by that an operation controlling section which operates only when impressed voltage meets a predetermined first condition, and a startup retarding circuit which is connected to said operation controlling section to apply voltage meeting said first condition to said operation controlling section after a predetermined period of time elapses commencing with the startup of said lighting equipment are arranged within said lighting equipment.

49. A power supply circuit according to claim 46, characterized by that the operation controlling section which operates only when impressed voltage meets the predetermined first condition, and the startup retarding circuit which is connected to said operation controlling section to apply voltage meeting said first condition to said operation controlling section after a predetermined period of time elapses commencing with the startup of said lighting equipment are arranged within said fluorescent lamp.

50. A power supply circuit according to claim 47, characterized by that the operation controlling section which operates only when impressed voltage meets the predetermined first condition, and a startup retarding circuit which is connected to said operation controlling section to apply voltage meeting said first condition to said operation controlling section after a predetermined period of time elapses commencing with the startup of said lighting equipment are arranged within said ballast.

51. A power supply circuit according to claim 48, characterized by that a power accumulating circuit which accumulates inputted current, and outputs it according to necessity is arranged within said lighting equipment.

52. A power supply circuit according to claim 49, characterized by that a power accumulating circuit which accumulates inputted current, and outputs it according to necessity is arranged within said fluorescent lamp.

53. A power supply circuit according to claim 50, characterized by that a power accumulating circuit which accumulates inputted current, and outputs it according to necessity is arranged within said ballast.

54. A power supply circuit provided with a transmitting section which uses electromagnetic induction to transmit power acquired from the internal circuit of a lighting equipment, and an interface which connects a transmitter which transmits a signal by using power transmitted by said transmitting section, characterized by that said transmitting section is connected in parallel with said preheating filament within said fluorescent lamp.

55. A lighting system provided with a transmitting section which uses electromagnetic induction to transmit power acquired from the internal circuit of the existing lighting equipment, and an interface which connects an external electric appliance operating by using power supplied from said transmitting section, characterized by that said transmitting section insulates said lighting equipment and said interface electrically from each other.

56. A lighting system according to claim 55, characterized by that said transmitting section comprises a transformer.

57. A lighting system according to claim 55, characterized in comprising a rectifying circuit which rectifies a voltage supplied from said transmitting section.

58. A lighting system according to claim 55, characterized by that said internal circuit is cable which connects a ballast and a fluorescent lamp located in said lighting equipment, or a preheating filament of a fluorescent lamp provided in said lighting equipment.

59. A lighting system according to claim 55, characterized in comprising a voltage boosting circuit which increases the voltage inputted from said transmitting section, and outputs it to said interface.

60. A lighting system according to claim 59, characterized by that said voltage boosting circuit has an operation controlling section which operates only when impressed voltage meets a predetermined first condition, and a startup retarding circuit which applies voltage meeting said first condition to said operation controlling section after a predetermined period of time has elapsed commencing with the startup of said lighting equipment.

61. A lighting system according to claim 55, characterized in comprising an power accumulating circuit which accumulates current supplied from said transmitting section, and outputs it according to necessity.
